(19) United States
(12) Patent Application Publication
(10) Pub. No.: US 2012/0209987 A1
(43) Pub. Date: Aug. 16, 2012

(54) Monitoring Use Of Tracking Objects on a Network Property

(76) Inventors: Edward D. Rhinelander, Melrose, MA (US); John Clayton Webster, Flemington, NJ (US); Faber Fedor, Somerville, NJ (US); Aaron Kulick, San Francisco, CA (US)

(21) Appl. No.: 13/028,231

(22) Filed: Feb. 16, 2011

(51) Int. Cl. G06F 15/173

(52) U.S. Cl. 709/224

(57) ABSTRACT

A collection of tracking objects that are provided with more resources of a network property are programmatically identified. Information about individual tracking objects of the collection are analyzed. A classification attribute is determined for at least some of the individual tracking objects based at least in part on the analyzed information. The classification attribute is indicative of whether the tracking object is known or in compliance with a policy of the network site that pertains to use of tracking objects.

### TECHNICAL FIELD

Embodiments described herein pertain to monitoring use of tracking objects on a network property.

### BACKGROUND

Computer cookies are examples of small data files which are deposited from network sites onto end user terminals as end users perform various web-browsing activities. Cookies serve many purposes and can enable various sorts of functionality. More recently, tracking cookies (sometimes referred to as “profiling cookies” or “persistent cookies”) have been used to collect information about user's browsing activities. Tracking cookies are typically used by advertisers, who collect information about users for purposes such as creating marketing campaigns, profiling end users, or even selecting what advertisements are to be shown to specific end users.

The use of tracking cookies has raised privacy concerns for end users. In order to address privacy concerns, many sites and advertisers enable users to opt-out of receiving tracking cookies, or having tracking cookies track their browsing activities. For example, some sites let users opt-out of receiving tracking cookies when browsing on that site. The opt-out functionality can be enabled for individual end users via, for example, account settings or opt-out buttons appearing on web pages. Still further, some advertisers allow users to use opt-out cookies that prevent tracking cookies from that advertiser to be deposited on the user's terminal.

There have also been attempts at creating industry-level opt-out mechanisms for enabling tracking functionality on end-user terminals. For example, the Network Advertising Initiative (NAI) has created a self-regulatory program that incorporates use of an industry opt-out cookie.

### BRIEF DESCRIPTION OF THE DRAWINGS

FIG. 1 is a simplified block diagram of components and processes that provide functionality for monitoring use of tracking objects on a network site or property, according to embodiments.

FIG. 2 illustrates a system architecture for monitoring usage of tracking functionality on a website or network property, according to embodiments.

FIG. 3 illustrates a method for collecting information and data on tracking objects, according to one or more embodiments.

FIG. 4 illustrates a method for policing tracking objects on a network property, according to one or more embodiments.

FIG. 5 illustrates a registry for maintaining information about third-party tracking objects that are encountered for a given site or property.

FIG. 6 is a block diagram that illustrates a computer system upon which embodiments described herein may be implemented.

### DETAILED DESCRIPTION

Embodiments described herein include a system and method for monitoring tracking objects on a network site or property.

According to embodiments, a system or method is provided to programmatically identify collection of tracking objects that are provided with more resources of a network property. Information about individual tracking objects of the collection are analyzed. A classification attribute is determined for at least some of the individual tracking objects based at least in part on the analyzed information. The classification attribute is indicative of whether the tracking object is known or in compliance with a policy of the network site that pertains to use of tracking objects.

According to some embodiments, tracking objects (e.g. tracking cookies) that are set on the viewers of a network property by a third-party are programmatically identified and analyzed, in order to determine a classification attribute for the individual tracking objects. By analyzing and classifying tracking objects, embodiments described herein facilitate monitoring the use of tracking objects on a network property. Some embodiments facilitate policing the use of tracking objects on a network property by identifying tracking object that are not known or potentially problematic (e.g. black-listed).

According to embodiments described herein, a tracking object corresponds to a file or data set that is stored on a user client, and which enables a user terminal, browser or browser profile to be identified by a server in a subsequent session or instance. Examples of tracking objects include tracking or persistent cookies, Flash cookies, and beacons. Such tracking objects are typically used to track browsing activities of an end user. In particular, tracking objects such as provided with persistent cookies can track what web pages a user visits over multiple browsing sessions.

According to an embodiment, a collection of tracking objects is programmatically identified from one or more resources (e.g. web pages) of a network site. Information about individual tracking objects of the collection is analyzed. A classification attribute is determined for at least some of the individual tracking objects, based at least in part on the analyzed information. The classification attribute is indicative of whether the tracking object is known or in compliance with a policy of the network site that pertains to use of tracking objects.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

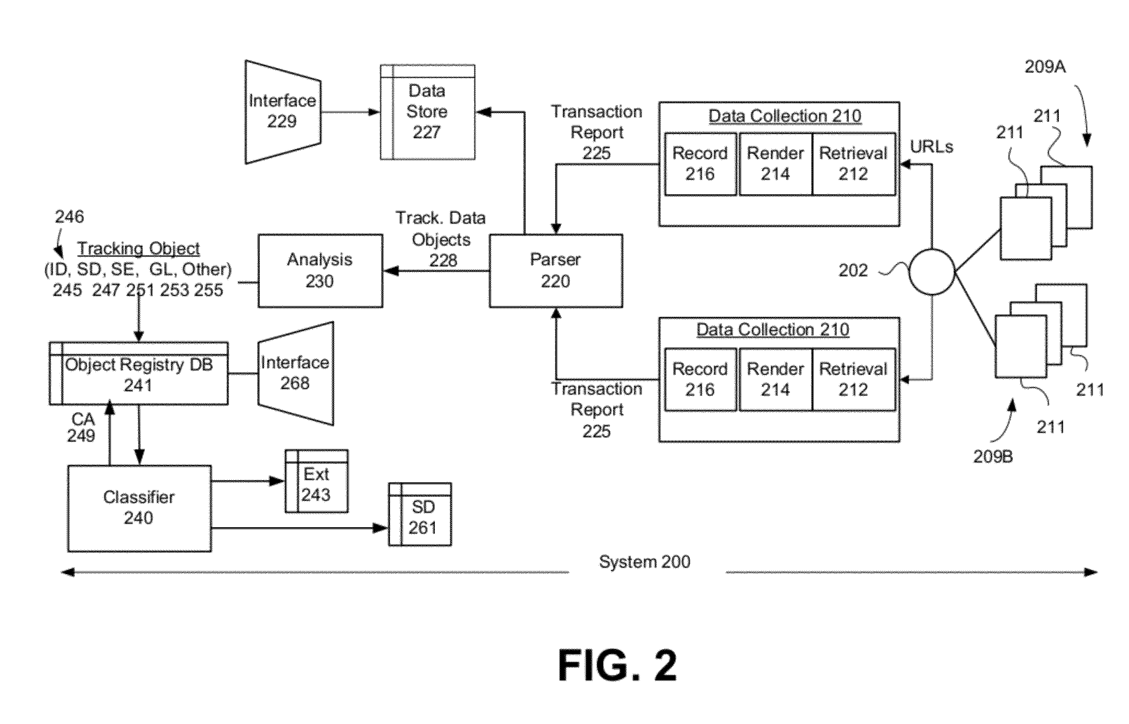

Furthermore, some embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines (e.g. servers or client terminals, such as referenced with an embodiment of FIG. 2) shown with embodiments herein include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

Overview

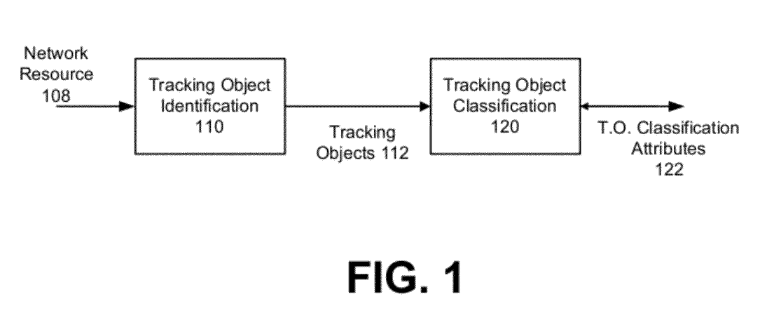

FIG. 1 is a simplified block diagram of components and processes that provide functionality for monitoring use of tracking objects on a network site or property. According to an embodiment such as shown in FIG. 1, a combination of processes are implemented to identify and monitor tracking objects deployed on a network property (or website). The processes combine to identify tracking objects in order to monitor use of such tracking objects on the network property. The monitoring enables the network property to exercise some control as to how third-parties such as advertisers track users that browse the network site or property. Among other controls, a site or network property can monitor third-party tracking objects to ensure their use is in compliance with policies (e.g. published privacy policy of a site) of the site or property.

In an embodiment, object identification processes 110 analyze a network resource 108 (e.g. web page) of the network site or property in order to identify objects, such as cookies (e.g. session cookies, Flash cookies, persistent cookies). Numerous types of objects are identified as a result of the identification processes 110, including, for example, identification of session cookies, or cookies provided by an operator of the network property on which the resource 108 is provided. The objects identified by the processes 110 may be subjected to parsing, filtering and/or additional analysis for purpose of identifying those objects that are likely to be tracking objects. Such tracking objects include permanent or persistent cookies, and variants there of (e.g. beacons or Flash cookies).

In some embodiments, the identification process 110 performs additional operations to identify those tracking objects (e.g. tracking cookies) that are set by a third-party. A third-party object, such as a persistent cookie, can be identified as being set from a domain that is not used or associated with network site 102 or property. In such instances, the object can be considered to be set by a third-party. In this way, processes described with an embodiment of FIG. 1 may be used to monitor tracking objects that are provided by third-parties, under assumption that the tracking objects of the site operator or in compliance with the policies of the site.

Object classification processes 120 determine a classification attribute for identified tracking objects. The classification attributes are indicative of whether the tracking objects 112 are known and/or in compliance with the policy of the site pertaining to the use of tracking objects. In determining classification attributes, the classification processes 120 analyze data attributes of individual tracking objects, as well as contextual information about the objects. The classification attributes can be identified by way of classification designations or scores. Additionally, other classification attributes can also made for identified tracking objects, such as attributes for classifying the tracking object by purpose of their use.

According to embodiments, the classification processes 120 analyze information provided with individual tracking objects in order to assign classification attributes to the individual objects. In particular, the classification processes 120 can analyze tracking objects by (i) determining an identifier for individual objects in order to identify whether the particular object is known or has been previously encountered; (ii) determining a source domain of the object and associating the object with a classification attribute that is based on information known (or not known) about the source domain; and/or (iii) determining information about an entity that set the object on the network resource (e.g. from IP address or source domain associated with tracking object, or by commercial content provided with a cookie). The classification attributes that can be assigned to tracking objects are indicative of (i) the particular tracking object being known, and/or (ii) the tracking object being in compliance with policies of the site.

The classification processes 120 can determine an identifier of the tracking object in order to determine whether the particular tracking object has previously been encountered. Tracking objects, such as cookies, can be identified from the attributes of the object. For example, cookie identification can take place by either identifying a cookie by a specific identifier, or by combining cookie attributes (e.g. path, domain and name value pair) to formulate an identification of the cookie name. The identifiers that are determined form tracking objects can be referenced to a database (or other data structure such as a table) of identifiers for known objects (e.g. white listed cookies). For example, cookies can be listed in a database when identified in a first instance, and the table can be used to determine whether individual cookies have previously been identified. For individual tracking objects 112 that are identified as having previously been encountered (e.g. they are on a table of known tracking cookies), the classification of the object may reflect the object's known status, as well as incorporate previous classification attributes of the object (e.g. the object was previously white-listed).

When tracking objects 112 identified from the identification process 110 are unknown, analysis is performed on attributes and related information of the individual objects. In some embodiments, a source domain of the tracking object is identified from the attributes of the tracking object. The source domain identifies the network domain from which the object was set on the network resource. For example, tracking cookies include attributes that identify a domain or IP address as a source from which the particular cookie was provided, in connection with a content item (e.g. advertisement) on a webpage. The classification processes 120 may, for example, designate classification attributes to track objects based on the source domain (e.g. tracking objects may be white-listed when originating from a particular domain).

As an alternative or addition, the classification processes 120 may identify the source domain in order to identify a policy of use for the tracking object. For example, the use policy of the domain pertaining to tracking cookies may be manually or programmatically retrieved from the domain and maintained as reference, or alternatively analyzed for compliance with the policy of the site. Still further, one embodiment provides that the source domain is inspected for functionality or settings that enable, for example, users to opt-out of receiving the tracking object.

The source domain can also be referenced to an entity or source. The source entity can be identified using, for example, attributes of the object such as source domain or Internet Protocol (IP) address of the server collecting information from that object. Information about the entity may be used to infer information about the object. For example, if the entity or source is known, trusted or in compliance with site policy, the domain attribute can serve as an implicit voucher of the tracking object. Additionally, the source entity may be known to subscribe to a particular privacy standard that is in agreement with the policy of the site on which the resource 108 is provided. Numerous other pertinent inferences can also made from domain information, such as whether the source domain or entity is associated with a self-regulating industry white list, or whether there are recorded instances of the source domain being a policy violator on the site in question or on other sites. In the latter case, for example, the source domain may be associated with an entity that is known to not provide an opt-out cookie for end-users, while the policy of the site on which resource 108 is provided may require that all tracking cookies are to be provided with opt-out mechanisms.

In addition to analyzing attributes of the tracking objects, some embodiments analyze data using additional information that is associated or derived from the tracking object. For example, a source content may be linked to a particular tracking object (e.g. the tracking object is stored on a user machine when the source content is rendered on the machine). The source content linked to the tracking object can be analyzed for type (e.g. whether the content is a pop-up or pop-under) or identification. In addition, the type of calls that are made when the source content is rendered may be identified and used to classify the attribute.

As still another variation, geographic localities pertinent to the tracking object can be inferred from attributes of the individual object, as well as from associated information provided with the source content. For example, tracking cookies can be paired with a server that receives information from terminals of end users that store the tracking cookie. The location of the server that receives information from the tracking cookie may be recorded. Additionally, the geographic location of the source entity, and/or the domain identified by attributes of the tracking object can be used to determine pertinent geographic localities of the tracking object. Information about geographic localities can be used for various purposes. In particular, a network site may implement different policies for different geographic regions, and the pertinent geographic localities of the objects may be used to ensure that select tracking objects are in compliance with geographically-pertinent policies of the site.

The classification processes 120 can assign classification attributes to tracking objects based on determinations made by analyzing the objects. In some embodiments, the classification(s) that are associated with individual objects are used to control, or at least monitor, third-party use of tracking objects (e.g. tracking cookies) on a website or network property (e.g. collection of websites or domains, portal etc.). Accordingly, the classifications associated with individual objects may include classifiers that identify individual tracking objects as (i) known/unknown, and/or (ii) approved/non-approved (or alternatively white/black listed). An object that is associated with the classification of being known may, for example, be trusted, or presumed to be in compliance with privacy terms or concerns of the particular website on which the resource 108 is provided. Similarly, a tracking object that is trusted may, for example, be white-listed or provided from a source that is known to be trusted.

As an alternative or variation to classification assignments, the classification attribute of individual tracking object may be provided as a score. The score may, for example, quantify a degree to which a source of a particular tracking object is known or unknown. Scoring can also quantify a degree of certainty to which, for example, the use of a particular tracking object is known or inferred to be in compliance with the policy of the site.

An output 122 of classification processes 120 may (i) identify third-party tracking objects, and (ii) identify the classification attribute for the tracking object. In one embodiment, the output 122 is provided as a list or table that can be used to police and enforce compliance of the site privacy policy by third-party tracking objects. Other information that may be included with the output 122 include select attributes of the tracking object (e.g. source domain and/or entity), as well as additional classification attributes (e.g. determined purpose of the tracking object).

If the object is associated or scored with the classification of being unknown, some embodiments provide cautionary protective measures to be taken, such as (i) researching the source of the unknown date of element to determine whether the object can be trusted (e.g. reviewing functionality of the object, reviewing privacy policy), or (ii) sending a notification to the domain or entity that is responsible for the tracking object in order to obtain information pertinent to determining policy compliance.

In some instances, the site may determine that enforcement is warranted for a given tracking object. Such object may be classified or scored to be unknown and/or not approved. Enforcement actions may be taken to police the site based on the classification attribute assigned to individual tracking objects. Enforcement actions can include (i) sending a notification to the source of the tracking object to request compliance with site policy or removal of the tracking object; (ii) removing or blocking the source content that sets the unknown tracking object (e.g. preclude the commercial content of an unknown cookie from being present on a webpage); and/or (iii) reporting the source domain or entity of the object to an industry or agency monitoring authority

As a variation to known/unknown, the objects can be classified as being trusted or not trusted (white/black listed). Content that incorporates the blacklisted object may be subject to enforcement.

Additional or alternative classifications can also be provided for tracking objects. For example, objects can also be classified by purpose or type.

System Architecture

FIG. 2 illustrates a system architecture for monitoring usage of tracking functionality on a website or network property, according to embodiments. A system 200 includes a data collection component 210, a parser 220, an analysis component 230, and a classifier 240. The data collection component 210 includes functionality corresponding to retrieval 212, render 214 and record 216. Additional components may be provided as needed. In particular, multiple data collection components 210 can be used to enhance system output and accommodate variations to site logic that are based on parameters such as geography.

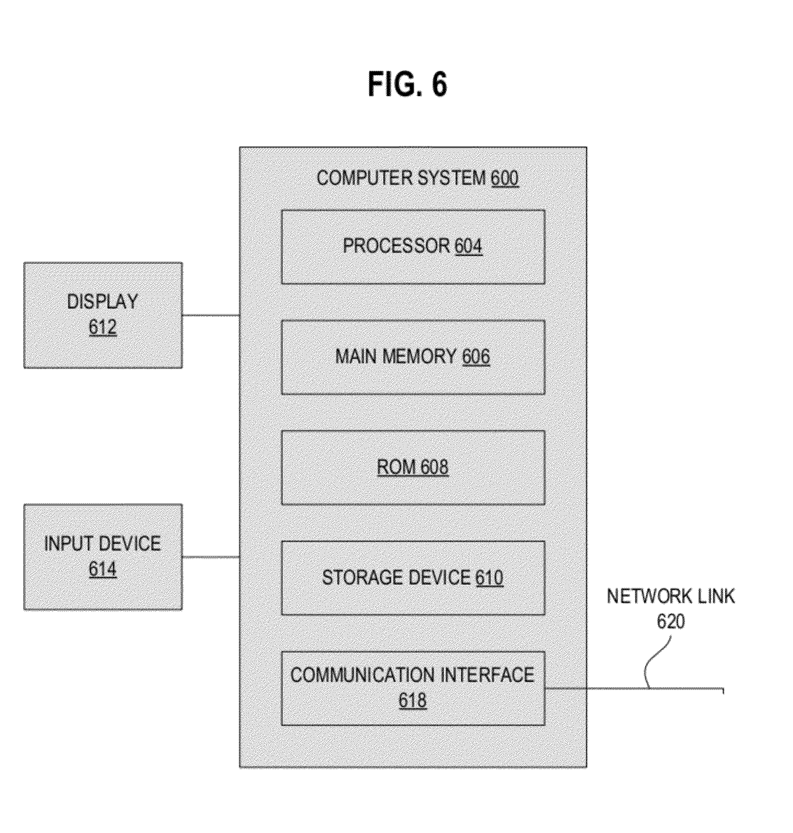

According to some embodiments, a system such as described with FIG. 2 may be implemented by a server, or a combination of servers. However, other non-server computing environments can alternatively be used. For example, the data collection component 210 can be run from a server functioning to appear as a client terminal, or on an actual client terminal. An example of a computer system on which an embodiment such as described can be implemented is provided with FIG. 6.

As shown, system 200 is implemented on a network property 202, which can comprise multiple domains 209A, 209B or sites. The network property hosts resource such as web pages 211. On a network property, resources such as web pages can be located by a Uniform Resource Locator (URL).

With reference to data collection component 210, retrieval 212 corresponds to logic for providing programmatic (e.g. by robot) access and retrieval of web pages and resources of the site 202. Retrieval 212 may include scheduling functionality to set intervals in which pages are identified from the site(s) of the network property. Retrieval 212 may also sample pages from the property 202, rather than retrieve all pages or resources of the site. For example, retrieval 212 may select, for retrieval, pages that are most frequently rendered on the site 202 in a given duration.

Render 214 includes logic for rendering the individual resources located from retrieval 212. For example, the retrieval 212 may identify URLs of the site 202, and render 214 uses the URLs to render the individual pages or resources. In one embodiment, the render 214 is implemented as functionality that appears on the site(s) of property 202 as a standard commercially available browser. In this implementation, render 214 (i) loads web pages from the site 202, (ii) renders various data formats such as Flash and Javascript, and (iii) accepts data objects provided on the sites of the property 202 (e.g. cookies, Flash cookies and beacons). In some embodiments, the rendering component 214 is structured to identify itself as residing outside of the domain of the property 202. Additionally, in some embodiments, multiple instances of render 214 (or the data collection component 210) are implemented, and the different instances are operated from (or made to appear as being implemented from) different geographic locations. The disparity in geographic locations may better identify use of location-specific tracking objects.

Record 216 includes logic of data collection component 210 which records transactions that occur when each of the selected resources or webpages is rendered. For example, record 216 can correspond to a program that records (i) individual headers that are transmitted from the client browser (as provided by render 214) when a webpage is loaded, (ii) what data objects (e.g. cookies) are used when the webpage is rendered, and (iii) what data objects (e.g. cookies) are encountered on the rendered webpage. In one embodiment, the record 216 is configured to identify all (or as many as possible) transactions on a given page or resource, including data objects (tracking cookies, session cookies, Flash cookies, beacons etc) and their respective attributes (source domains, name value pairs, associated content etc.), as well as programmatically set cookies (e.g. those cookies set by Java or Flash programming).

An output of record 216 includes a transaction report 225 which identifies individual transactions that were recorded as a result of a URL from one of the web-pages 211 being rendered. The report 225 also lists the various data objects that were encountered on different pages. In one implementation, the transaction report 225 is provided as an HTTP Archive Report (HAR). In such format, the report 225 includes semantic information which can be parsed to identify individual transactions, events and data objects involved in the rendering of one of the pages 211. In some embodiments, all (or substantially all) of the data objects that are provided with a web page are identified, including information such as parameters or attributes of the individual objects. For example, all cookies provided on a web page may be identified in the report 225, along with parameters such as the source domain from which the cookie was set, the value of the cookie (e.g. name value pair), and/or the content (e.g. advertisement) that is associated with the cookie.

In one embodiment, the transaction reports 225 are maintained in a data store 227 or collection for access by users. A user interface 229 may enable the end user to access the data store 227 for purpose of analysis. For example, the user can interactively discover the source of cookies, to enable analysis on the origin or nature of the cookie.

System 200 includes components that analyze the transaction report 225 in order to identify third-party tracking objects on the network property 202. According to an embodiment, a parser 220 processes information from the report 225 to (i) identify tracking objects from collection of data objects loaded on each page, and (ii) filter third-party tracking objects from the larger set of tracking objects. The tracking objects may be correspond to data objects that are permanently stored on the user's terminal (e.g. permanent cookies, but not session cookies). Such data objects may serve to identify the user's terminal or browser to a server in subsequent web browsing sessions. The transaction report identifies the domain associated with each tracking object. Those domains that are part of the network property 202 may be filtered out to identify the third-party tracking objects. Thus, non-tracking objects, such as session cookies, as well as objects that are set from within the domain (or associated domain) of property 202 are excluded from further analysis as to source or compliance. A remaining set of objects 228 includes significantly, tracking objects set by third-parties, such as persistent cookies, cross-domain cookies, and beacons.

The analysis component 230 analyzes parameters of the tracking objects 228 (e.g. from report 225), as well as information provided with the individual tracking objects 228, in order to determine information about particular tracking objects. The information for a particular tracking object includes data attributes 246 of individual object. The data attributes 246 determined by the analysis component 230 can include an object identifier 245, which can be determined from one or more parameters of the tracking object (e.g. date of creation, source domain, IP address etc.). The object identifier 245 can be used to determine whether the particular object is known to system 200 (e.g. it was previously encountered), or known to other resources available to the system 200. In one embodiment, the analysis component 230 maintains an object registry database 241 that identifies third-party data objects that have previously been encountered by system 200, or which are otherwise known to the system.

In addition to object registry database 241, some embodiments provide that the analysis component 230 accesses industry level lists 243 that directly or indirectly designate classification attributes to tracking data objects. As examples of the latter case, industry lists may identify (i) source domains that provide tracking objects which meet (or do not meet) industry or standardized guidelines, or (ii) specific tracking objects which meet (or do not meet) industry or standardized guidelines. In this way, the classification of the tracking object may rely on prior classification determinations, made internally or externally.

According to an embodiment, if a third-party tracking object is unknown (not on the object registry database 241), data attributes and information is determined about the data tracking object and stored in the registry database 241, referenced against the identifier of the object. In this way, the output of the analysis component 230 can be used to update lists for future use by the classifier. For example, identifiers of tracking cookies that were previously unknown may be determined and added to the registry database 241, along with the classification attribute that was determined by, for example, researching the source domain and/or entity of the particular cookie. The system 200 may progressively become more knowledgeable and capable of identifying tracking objects without domain or source analysis.

Among data attributes that can be determined for newly encountered data attributes, the analysis component 230 identifies a source domain 247 (i.e. the domain that set the tracking object on the resource of the network property 202). Information known or obtained about the source domain 247 can be used to determine the classification attribute of the tracking object.

The analysis component 230 may also deduce or infer attributes from other attributes or parameters that are explicit (e.g. source domain) in the transaction report 225. One type of information that can be determined from the report 225 includes determinations of the source entity 251. The source entity determinations 251 may identify the entity (e.g. advertiser) responsible for the tracking object being present on the site. The source entity determinations 251 can be included on the registry database 241 and referenced against a tracking object.

As an addition or variation, another type of attribute that can be deduced for a tracking object includes a geographic locality determinations 253. The geographic locality determination 253 identifies geographic localities that are pertinent a particular tracking object. The geographic locality determinations 253 can be made from one or more of (i) an IP address of the server (or domain) associated with the tracking object, cross-referenced with geo-mapping source that identifies a locality to an IP Address; (ii) company reference information, such as the headquarter and/or server location, for the source entity that set the tracking object. The geographic information may also be included in the registry database 241. Geographic locality determinations 253 can be used to implement geographic-specific policies on the network property 202.

Other attributes 255 or characteristics may be determined from analyzing the object information (as provided in report 225) to determine classification attributes of the tracking object. Such other attributes may include, for example, contextual information, such as information from the source content that sets the tracking object. For example, the content item with which the tracking object is set can be characterized by structure or type (e.g. pop-up, pop-under), by type of functional calls performed to render the content, and/or by the data type (e.g. Flash) of the associated content.

Some of the analysis and research performed for tracking objects that are unknown, or from unknown domains or sources, is manual. Accordingly, embodiments recognize that the use of lists that indicate what specific tracking objects or domains are known or trusted can be beneficial to reduce the manual involvement of subsequent research.

The classifier 240 determines the classification attribute for individual objects 228. The classification attribute may be used as an indication or determination as to whether a particular tracking object (or its use) is in compliance with one or more policies of the site. As mentioned, the classification attribute corresponds to a classification designation (e.g. known, approved, white-listed etc.) or to a classification score. The classifier 240 may identify the classification attribute of the object using data attributes (e.g. source domain, source entity) associated with the tracking object. Also, if the tracking object is known, the classification attribute of the particular object may have previously been determined. The classifier 240 may also update the classification attribute(s) of a tracking object. Once the classification attribute is determined, it can be stored in the object registry database 241 for future use.

According to some embodiments, the classification attribute 249 for a newly encountered tracking object can be determined from the source domain of the tracking object. For example, the source domain 247 can be referenced against a library 261 of information known about various source domains which set cookies and other tracking objects on the site. The information about the source domain may, for example, identify privacy policies and functionality of the source domain. The classifier 240 may also access a list or registry of pre-determined classification attributes (e.g. classification designations or scores) for specific domains. Alternatively, the source domain may be identified from the data attribute of the tracking object, and a privacy policy of that domain can be retrieved and analyzed to determine whether the source domain's policy are in line with the policy of the network property 202.

Still further, in determining the classification attribute of the tracking object, the tracking object or its source may be reviewed to ensure that the tracking object has characteristics or functionality that enable compliance with the site's policy. For example, system 200 (or an operator of system 200) may include functionality for accessing the source domain of unknown tracking objects to identify (i) how the tracking object is used, and/or (ii) opt-out settings or functionality that may be triggered for use with objects that originate from that particular domain.

The classification attributes 249 that are determined by the classifier 240 for individual tracking objects can be included in the object registry database 241. In this way, the object registry database 241 maintains updated information about tracking objects and their respective classification attributes 249.

According to some embodiments, an interface 268 is provided for enabling use of data in the object registry database 241. In an embodiment, the interface 268 generates reports from object registry database 241, such as reports which convey (i) data and classification attributes for tracking objects on the site 202, (ii) updates to the list of tracking objects that operate on the site. As an addition or variation, interface 268 can generate notifications or alerts to signify, for example, (i) instances when a new tracking object is encountered, (ii) instances when a tracking object has an unknown classification, or (iii) instances when a tracking object has a classification attribute that is undesirable, including black-listed or suspicious tracking objects.

Such reports and notifications or alerts can be implemented to enable policy enforcement on the site 202. Such policy enforcement may involve both manual and programmatic actions. Unknown or unclassified tracking objects may be researched for classification. If classification attributes of a tracking object are unwanted, policy enforcement actions may be performed that include: (i) removal of the source content that provides the tracking object from the site, (ii) blocking all content from the provider of the source content; (iii) sending a notification to the source of the tracking object (e.g. the entity that provided the advertisement or associated content) to request information or compliance; or (iv) further monitoring of the domain or entity associated with the source content. Numerous other variations may be implemented to enforce the policies of the site with regard to tracking functionality and objects.

Methodology

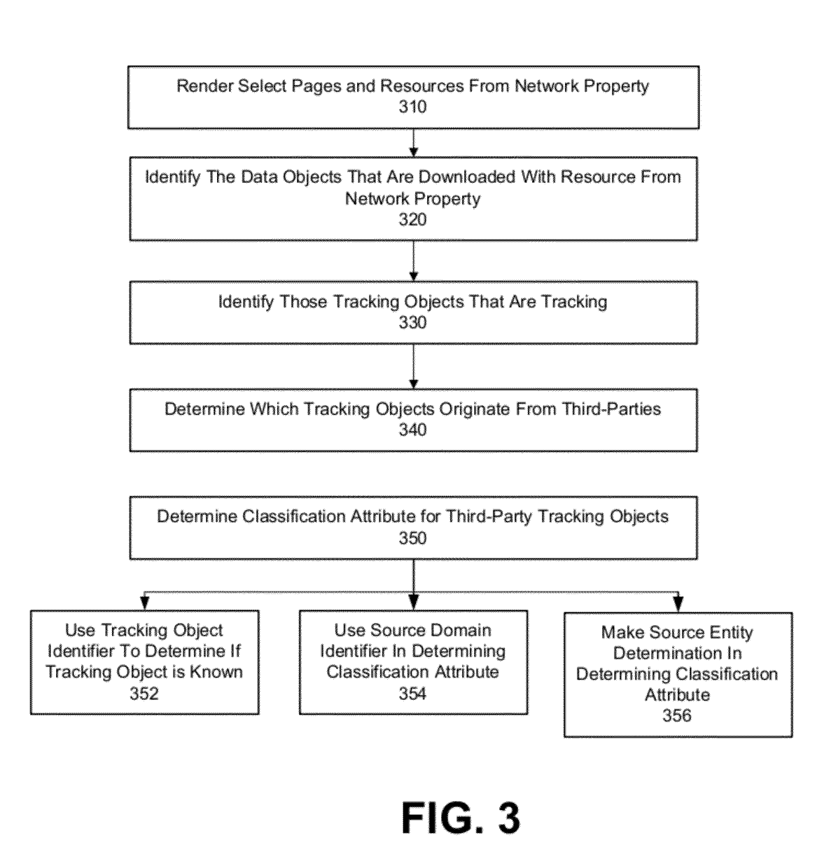

FIG. 3 illustrates a method for collecting information and data on tracking objects, according to one or more embodiments. A method such as described by FIG. 3 may be implemented using systems or processes such as described with FIG. 1 and FIG. 2. Accordingly, reference may be made to elements of prior embodiments for purpose of describing a suitable element or component for implementing a step or sub-step being described.

According to an embodiment, the data collection component 210 is operated to render pages and resources from the network property 202 (310). The data collection component 210 can be configured as a client that uses lists of URLs from the network property in order to render the corresponding resources. In some implementations, multiple data collection component 210 are used, operating from geographically diverse locations, in order to trigger geographic-dependent site functionality and cookies. In one implementation, retrieval functionality 212 of the data collection component 210 fetches URLs from the network property 202 in accordance with a retrieval scheme which may schedule retrieval events, and identify specific URLs to prioritize or select based on prioritization or sampling criteria.

The pages and resources located by the URLs are rendered to identify cookies, beacons and other objects that are provided with the individual pages. In one embodiment, all cookies and similar data items that are downloaded with a particular web page or resource of the network property are programmatically identified (320). Examples of such data objects include session cookies, permanent cookies, Flash cookies, cross-domain cookies and beacon variants. In one embodiment, the step is performed by the rendering functionality 214 of the data collection component 210 rendering pages and resources identified by the collected URLs. The recording functionality 216 records data and events that result from rendering the individual resources, including the various transactions that take place when a client terminal renders a web page or resource identified by one of the resources. The recorded transactions identify individual cookies and beacons that are set when the data collection component 210 renders the page.

The various data attributes of the cookies and beacons are also identified, including, for example, their source domain, set value, and their expiration date. The information recorded about the different objects also include information about the content (i.e. the source content) that is associated with the particular cookie or object, including type information about such content. Other information, such as information about the type of call made in connection with use of the cookie is also recorded.

Additionally, the data objects are analyzed to identify those that are tracking objects (330), or are likely to be tracking objects. Individual tracking objects may be distinguished, for example, by being identified of a type that (i) is permanently stored in a user's terminal, and (ii) serves to identify the terminal or browser in subsequent sessions. Thus, for example, session cookies can be ignored.

The identified cookies, beacons and objects are then analyzed to identify tracking objects that originate from sources outside of the network property (340). Thus, tracking cookies that originate from a domain of the network property are excluded from the identified set of elements. The resulting set of tracking objects originate from sources external to the domain of the network property. Such data objects can be assumed to be known and in compliance with policies of the network property.

The objects that are permanent and set from domains outside of the network property 202 are further analyzed in order to determine a classification attribute for the object.

Classification attributes are determined for third-party tracking objects (350). As mentioned, classification attributes may take form as classification designations, scores, or other parameters that indicate the classification of the tracking object. According to some embodiments, the classification attributes are particular as to how the tracking object conforms to privacy policy of the network property.

One or more determinations can be made to determine the classification attribute of a third-party tracking object. In one embodiment, a determination is made as to whether the tracking object is known based on identifiers of the element (352). An identifier of the tracking object can be determined from the data attributes of the tracking object. This identifier may be compared against an internal list (such as stored in the object registry database 241) of known tracking objects to determine whether the particular tracking object has previously been classified or reviewed. The identifier of the tracking object may also be compared to public lists of identifiers for tracking objects to determine whether public or industry-wide information exists for the particular tracking object.

As an addition or variation, the source domain of the tracking object is identified from data attributes of the tracking object (354). The source domain can be referenced with lists of known source elements in order to determine whether the source domain has a known privacy policy or feature, or whether it can be trusted. Lists of known source domains can be internal lists (those known by the network property) or industry wide lists. In the latter case, industry wide lists may, for example, identify source domains that subscribe to industry approved privacy policies or parameters.

In addition to source domain, the source entity of the domain or tracking object can be identified and used to determine the classification attribute (356). Information known about such source entities may be used individually (e.g. as replacement) or in combination with source domain information.

As still another addition or variation, geographic determinations can be made that are pertinent to a tracking object for purpose of identifying geographic-specific classification attributes of a object. Pertinent geographic determinations include identifying a geographic location of a server for the source domain or for collecting information from the tracking object. The geographic location of the source entity (e.g. corporate address) may also be identified. The pertinent geographic determinations can be referenced against geographic-specific policy requirements for the network property. For example, the privacy policy that is implemented on the network property may be different to accommodate privacy laws of neighboring countries, or even different states in the United States. In this way, some embodiments provide that the classification attribute may reflect geography specific classification attributes. For example, a tracking object may be blacklisted for failing to comply with a privacy policy of the network property at a particular geographic location.

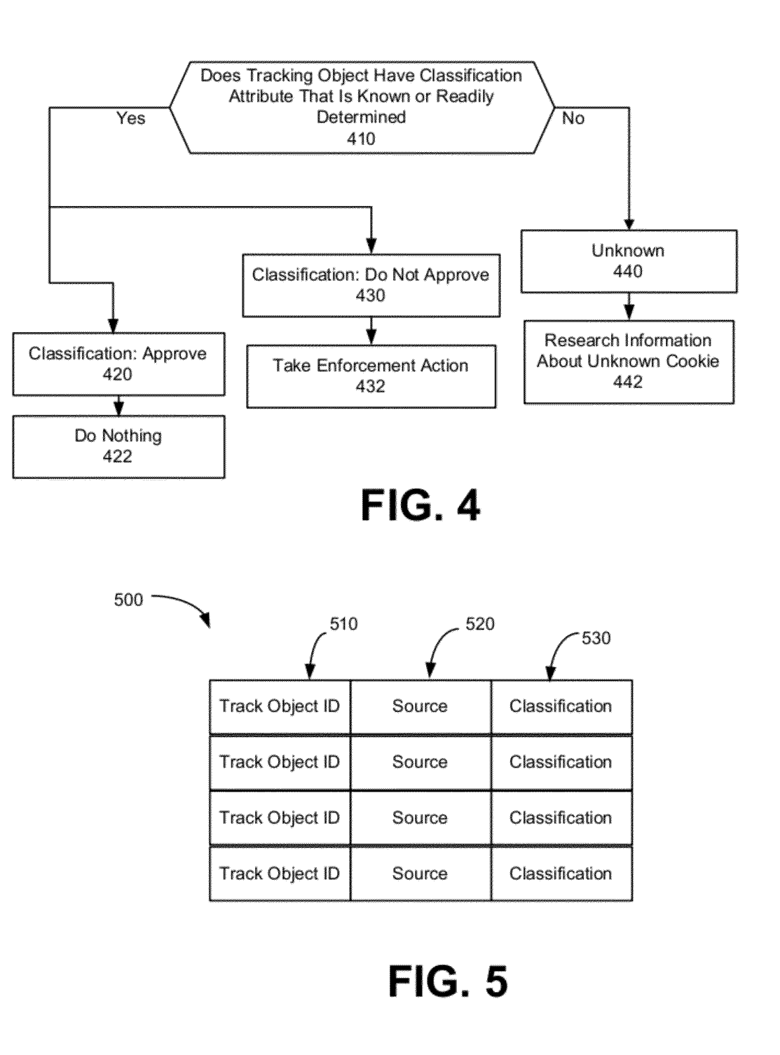

FIG. 4 illustrates a method for policing tracking objects on a network property, according to one or more embodiments. As with an embodiment of FIG. 3, reference may be made to elements of FIG. 1 or FIG. 2 for purpose of illustrating a step or sub-step being described.

For a given tracking object, a determination is made as to whether a given third-party tracking object has a classification attribute that is known or readily determined (410). The classification attribute of the tracking object may be known if, for example, (i) the particular tracking object has previously been encountered and analyzed or investigated; (ii) the source domain (or entity) of the tracking object is known or trusted; and/or (iii) the tracking object or its source domain is on an industry list. Other resources may be used to make the determination for the classification attribute of the tracking data object.

A tracking object that is known can have a classification attribute that indicates approval or non-approval. If the classification attribute indicates approval (420), no further action is needed (422). If the classification attribute indicates non-approval (e.g. blacklist) (430), various enforcement actions may be taken against the tracking object (432). Examples of enforcement actions include (i) automatic removing the offensive tracking object (along with the content that sets the tracking object; (ii) sending a notification to the source domain or entity of the tracking object to direct removal, or force compliance with policies of the network property regarding how data tracking objects are to be used; (iii) placing the tracking object or its source domain on a watch list (private or industry wide); and/or (iv) flagging the tracking object or its source domain for future monitoring.

If the classification attribute corresponds to “unknown” (440), additional research can be performed to determine a classification attribute for the particular tracking object (442). The classification attribute may correspond to the tracking object being approved or not approved. As a variation, the unknown tracking object may be monitored for compliance.

Registry

FIG. 5 illustrates a representative portion of a registry for maintaining information about third-party tracking objects that are encountered for a given site or property. A registry 500 is shown that lists newly encountered tracking objects with data attributes and determined classification attributes. The registry 500 may also be used to update information about known (or previously encountered) data tracking objects. According to some embodiments, the registry 500 can be incorporated into a system such as described in FIG. 2 for purpose of (i) determining whether a data tracking object is known (or previously encountered), and (ii) storing information about newly encountered tacking elements for subsequent use.

In FIG. 5, registry 500 lists individual tracking objects (e.g. cookies) as follows: (i) a tracking object identifier 510, (ii) a source entity for the tracking object 520, and (iii) classification attribute 530 for the tracking object (e.g. white-label, black-label, or unknown). Numerous other types of information may be maintained with registry 500 for individual data objects, such as source entity information, geographic determinations made about the tracking object, other classifications regarding the tracking object (e.g. purpose), parameters and other information that was included with the tracking object (e.g. identification of the content from which the tracking object was et).

As mentioned, the registry 500 may serve various purposes. In particular, the registry 500 provides a collection of knowledge regarding tracking objects that are provided on a given network property. In this way, tracking objects that are deployed on a network property can be monitored and analyzed, and information determined from the analysis can be used to facilitate subsequent policing of the site.

Reporting

Among other uses, embodiments provide that for various reporting features to be enabled from registry 500. As examples, the following reports may be generated from registry 500: (i) summary set of tracking objects provided with rendering of content for a given URL of the network property; (ii) identification of new domains that set or provide tracking objects; and (iii) listings of blacklisted objects, or objects that are linked to blacklisted domains (including diagnostic information and data encountered).

With reference to an embodiment of FIG. 2, reporting functionality may be provided by the interface 268. Some information, such as newly encountered domains or blacklisted cookies/domains, may be subjected to notification functionality, in which an alert or notification is generated for an operator or administrator of the system 200.

Computer System

FIG. 6 is a block diagram that illustrates a computer system upon which embodiments described herein may be implemented. For example, in the context of FIG. 2, system 200 may be implemented using a computer system such as described by FIG. 6.

In an embodiment, computer system 600 includes processor 604, main memory 606, ROM 608, storage device 610, and communication interface 618. Computer system 600 includes at least one processor 604 for processing information. Computer system 600 also includes a main memory 606, such as a random access memory (RAM) or other dynamic storage device, for storing information and instructions to be executed by processor 604. Main memory 606 also may be used for storing temporary variables or other intermediate information during execution of instructions to be executed by processor 604. Computer system 600 may also include a read only memory (ROM) 608 or other static storage device for storing static information and instructions for processor 604. A storage device 610, such as a magnetic disk or optical disk, is provided for storing information and instructions.

Computer system 600 can include display 612, such as a cathode ray tube (CRT), a LCD monitor, and a television set, for displaying information to a user. An input device 614, including alphanumeric and other keys, is coupled to computer system 600 for communicating information and command selections to processor 604. Other non-limiting, illustrative examples of input device 614 include a mouse, a trackball, or cursor direction keys for communicating direction information and command selections to processor 604 and for controlling cursor movement on display 612. While only one input device 614 is depicted in FIG. 6, embodiments may include any number of input devices 614 coupled to computer system 600.

Embodiments described herein are related to the use of computer system 600 for implementing the techniques described herein. According to one embodiment, those techniques are performed by computer system 600 in response to processor 604 executing one or more sequences of one or more instructions contained in main memory 606. Such instructions may be read into main memory 606 from another machine-readable medium, such as storage device 610. Execution of the sequences of instructions contained in main memory 606 causes processor 604 to perform the process steps described herein. In alternative embodiments, hard-wired circuitry may be used in place of or in combination with software instructions to implement embodiments described herein. Thus, embodiments described are not limited to any specific combination of hardware circuitry and software.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for monitoring use of tracking objects on a network property, the method being implemented by one or more processors and comprising:
programmatically identifying a collection of tracking objects provided with one or more resources of the network property, the individual tracking objects of the collection being usable to track an activity of an end user of the network property;
analyzing information about individual tracking objects of the collection; and
determining a classification attribute for at least some of the individual tracking objects based at least in part on the analyzed information, the classification attribute being indicative of whether the tracking object is known or in compliance with a policy of the network property that pertains to use of tracking objects.

2. The method of claim 1, wherein analyzing information about individual tracking objects includes determining information about a source of one or more of the tacking objects in the collection.

3. The method of claim 2, wherein determining information about the source includes (i) identifying a source domain of one or more of the tracking objects, and (ii) determining information about a privacy policy adopted by the identified source.

4. The method of claim 2, wherein determining information about the source includes (i) identifying a source domain of one or more of the tracking objects, and (ii) making a determination as a geographic location of the source of the one or more tracking objects.

5. The method of claim 1, wherein the classification attribute characterizes the tracking object or its source as known or unknown.

6. The method of claim 1, wherein the classification attribute characterizes the tracking object or its source as approved or not approved.

7. The method of claim 1, further comprising determining a classification attribute for a purpose of one or more of the tracking objects.

8. The method of claim 1, wherein analyzing information about individual tracking objects includes determining, for a given tracking object, one or more of (i) a data attribute of the given tracking object, and (ii) identification of a content source that the given tracking object is linked to.

9. The method of claim 1, further comprising:
making a determination, based on the analyzed information, as to whether the use of the tracking object on the network property is in compliance with the policy of the network property.

10. The method of claim 9, further comprising performing an enforcement action to enforce the policy based on the determination being that the given tracking object is not in compliance with the policy of the network property.

11. The method of claim 1, wherein analyzing information about individual tracking objects includes determining that the tracking object is persistent and not session-based.

11. The method of claim 1, wherein analyzing information about individual tracking objects includes determining that the tracking object originates from a domain that is remote and independent to that of the network property.

12. The method of claim 1, wherein the tracking object includes a tracking cookie or beacon.

13. The method of claim 1, determining a classification attribute for at least some of the individual tracking objects includes determining a score value of the individual tracking object as being less than or in between absolute values of a particular classification.

14. The method of claim 1, analyzing information about individual tracking objects includes determining information about a content source that sets one or more of the tracking objects on a resource of the network property.

15. A system for monitoring use of tracking objects on a network property, the system comprising:
one or more processors configured to provide:
a data collection component operable to (i) render a plurality of resources from a network property, and (ii) record information about individual tracking objects that are provided with the plurality of resources; and
a classifier that is operable to use data attributes provided with the individual tracking objects in order to determine a classification attribute for at least some of the individual tracking objects, the classification attribute being indicative of whether the tracking object is known or in compliance with a policy of the network property that pertains to use of tracking objects.

16. The system of claim 15, wherein the data collection component renders individual resources of the network property in order to identify data objects that include tracking objects, and records the individual data objects that are encountered when the individual resources of the network property are rendered.

17. The system of claim 15, wherein the data collection component generates data that identifies the individual data objects that are recorded when the individual resources of the network property are rendered, and wherein the one or more parsers further provide a parser which parses the generated data to identify the identified data objects that are tracking objects.

18. The system of claim 17, wherein the parser is operable to identify tracking objects that originate from a source outside of the network property.

19. The system of claim 18, wherein the generated data is provided as a transaction report which includes semantic information that identifies individual data objects and their respective data attributes.

20. The system of claim 18, further comprising an analysis component that identifies the data attributes of individual tracking objects.

21. The system of claim 18, wherein the analysis component is operable to infer additional attributes of individual tracking objects from data attributes of the tracking object.

22. The system of claim 18, wherein the inferred attributes include a source entity and/or one or more geographic localities that are pertinent to the tracking object.

23. The system of claim 18, further comprising an object registry database that stores a record for each tracking object which is identified and determined to originate from a source that is external to the network property.

24. A system for monitoring use of tracking objects on a network site, the system comprising:
one or more processors configured to provide:
a data collection component operable to (i) render a plurality of resources from a network property, and (ii) record information about individual tracking objects that are provided with the plurality of resources;
a classifier that is operable to use the information provided with the individual tracking objects in order to determine a classification attribute for at least some of the individual tracking objects, the classification attribute being indicative of whether the tracking object is known or in compliance with a policy of the network site that pertains to use of tracking objects; and
an object registry database that stores a record for individual tracking objects, including information to associate individual tracking objects to the classification attribute that is determined for that tracking object.

25. The system of claim 24, wherein the system includes one or more components to identify a subset of tracking objects that originate from a source that is external to the network property, and wherein the classifier operates to identify the classification attribute for each of the tracking objects in the subset.

26. The system of claim 25, wherein the classifier determines a classification attribute that is indicative of the tracking object in the subset being known or unknown.

27. The system of claim 26, wherein the classifier determines the classification attribute of a given tracking object in the subset to be known as a result of a source for the given tracking object being known or trusted.

28. The system of claim 25, wherein the subset of tracking objects include a third-party tracking cookie, Flash cookie, or beacon.
